(19) United States
(12) Patent Application Publication
(10) Pub. No.: US 2025/0390173 A1
(43) Pub. Date: Dec. 25, 2025

(54) WEARABLE COMPUTING DEVICES FOR SPATIAL COMPUTING INTERACTIONS

(71) Applicant: Olaoluwa O. Adesanya, Redmond, WA (US)

(72) Inventor: Olaoluwa O. Adesanya, Redmond, WA (US)

(21) Appl. No.: 19/064,028

(22) Filed: Feb. 26, 2025

Related U.S. Application Data
(63) Continuation of application No. PCT/US23/31245, filed on Aug. 28, 2023.
(60) Provisional application No. 63/401,844, filed on Aug. 29, 2022.

(51) Int. Cl. G06F 3/01; G06F 3/03

(52) U.S. Cl. CPC G06F 3/014; G06F 3/017; G06F 3/0304

(57) ABSTRACT

Wearable computing devices, which can be adapted to be worn on a user's hand, are provided for spatial computing interactions. Generally, the wearable computing device can include one or more processors, non-transitory memory for storing instructions, one or more multicolored light-emitting diodes, and a first set of sensors configured to measure positional characteristics associated with a user's hand. The wearable computing device can further comprise a plurality of leads each of which is attached to a finger, and comprises a distal portion that houses a multicolored light-emitting diode and a second set of sensors. The second set of sensors can be configured to measure positional characteristics associated with the user's fingers.

### CROSS-REFERENCE TO RELATED APPLICATIONS

This application is a continuation of International Patent Appl. No. PCT/US23/31245, filed Aug. 28, 2023, which claims priority to, and the benefit of, U.S. Provisional Patent Appl. No. 63/401,844 filed Aug. 29, 2022, both of which are incorporated by reference herein in their entireties and for all purposes.

### FIELD

The subject matter described herein relates generally to wearable computing devices for spatial computing interactions, as well as systems and methods relating thereto. Generally, a wearable computing device to be worn on a user's hand is provided, and comprises: one or more processors; non-transitory memory for storing instructions; at least one haptic motor; one or more sensors and/or cameras adapted to sense positional characteristics of the user's hand; a plurality of flexible leads adapted to attach to the user's fingers, and wherein each flexible lead includes a haptic motor and sensors adapted to sense a plurality of positional characteristics associated with the user's fingers. In some embodiments, the wearable computing device further includes: one or more multicolored light-emitting diode; one or more speakers; a subwoofer; a microphone; and/or ultrasonic transducers.

### BACKGROUND

Advances in computing technology, such as faster and more powerful processors, component miniaturization, cloud computing, and advanced sensor technology have paved the way for virtual reality, augmented reality, artificial intelligence, and spatial computing. Virtual and augmented reality (respectively, “VR” and “AR”) technologies provide unique ways by which users can visualize and experience information. These technologies typically involve a user wearing a head-mounted display (“HMD”) with a display portion positioned directly in front of the user's eyes. Visual data is then transmitted to the HMD for display to the user. HMDs can utilize stereoscopic displays and special lenses to give the illusion that the user is physically inside a VR environment, or in the case of AR, that a virtual object appears in the real world. Artificial intelligence (“AI”) describes technology in which a computer is able to perform tasks normally requiring human intelligence, such as speech and/or object recognition. In this regard, VR AR and AI technologies provide for a variety of unique and immersive experiences, and have found applications in a diverse range of industries including video games, the cinematic arts, medicine, military training, real estate, manufacturing, education, and journalism, to name a few.

Despite many applications, the ability for users to interact with objects in a VR or AR environment, or with a computer using AI technology, remains limited. In some VR and AR environments, for example, users can see virtual objects, but the ability to touch, feel or otherwise interact with the virtual objects is limited or, in many cases, not possible at all. Likewise, the ability for users to utilize AI for interactions with objects in either the real world, or VR/AR, is limited. For example, in systems that allow for interactions through a handheld controller, sensory feedback and positional tracking can often be constrained by the limited processing power and/or bandwidth of the computer to which a user's HMD is tethered. This problem is further exacerbated in systems that utilize mobile computing devices, which can have even fewer computing resources.

Thus, there is a need for improved and more efficient systems, devices and methods for spatial computing interactions.

### SUMMARY

Provided herein are example embodiments of wearable computing devices for spatial computing interactions, as well as systems and methods relating thereto. Generally, a wearable computing device is provided, wherein the wearable computing device can be worn on a user's hand, and comprises a controller portion that includes, at least, one or more processors, non-transitory memory for storing instructions, at least one haptic motor, and a first set of sensors adapted to sense positional characteristics of the user's hand. In many embodiments, the wearable computing device also comprises an accessory portion that can include, at least, a plurality of flexible leads, each of which is configured to attach to a finger of the user's hand, a haptic motor and a second set of sensors adapted to sense a plurality of positional characteristics of the user's fingers.

According to an aspect of the embodiments, the wearable computing device can further include one or more multicolored light-emitting diodes (“LEDs”), one or more speakers, a subwoofer, a microphone, and/or one or more ultrasonic transducers.

These embodiments and others described herein reflect improvements in the computer-related fields of spatial computing interactions over prior and existing methods and systems. The various configurations of these systems, devices, methods, features, and advantages are described by way of the embodiments which are only examples. Other systems, devices, methods, features and advantages of the subject matter described herein will be apparent to one with skill in the art upon examination of the following figures and detailed description. It is intended that all such additional systems, devices, methods, features, and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1 is a perspective view of an example embodiment of a wearable computing apparatus for immersive computing environments and AI interactions.

FIGS. 2A and 2B are perspective views of another example embodiment of a wearable computing apparatus for immersive computing environments and AI interactions.

FIG. 3A is a top view of another example embodiment of a wearable computing apparatus for immersive computing environments and AI interactions.

FIG. 3B is a perspective view of a portion of an example flexible lead component of a wearable computing apparatus for immersive computing environments and AI interactions.

FIGS. 3C, 3D, and 3E are side views of an example first subassembly of a wearable computing apparatus for immersive computing environments and AI interactions.

FIG. 4 is a block diagram of an example embodiment of a first subassembly of a wearable computing apparatus for immersive computing environments and AI interactions.

FIG. 5A is a flow diagram of an example embodiment routine for immersive computing environments and AI interactions using a wearable computing apparatus.

FIGS. 5B, 5C, and 5D are perspective views of an example embodiment of a wearable computing apparatus for immersive computing and AI interactions in various uses.

FIG. 6A is a perspective view of another example embodiment of a wearable computing device for spatial computing interactions.

FIG. 6B is a perspective view of an example embodiment of a pair of wearable computing devices for spatial computing interactions.

FIGS. 6C and 6D are close-up perspective views of another example of a wearable computing device for spatial computing interactions.

FIGS. 6E to 6H are perspective views of example embodiments of a wearable computing device for spatial computing interactions in various uses.

FIG. 7 is a perspective view of another example embodiment of a wearable computing device for spatial computing interactions.

FIG. 8 is a side view of another example embodiment of a wearable computing device for spatial computing interactions.

FIG. 9 is a drawing showing a partial view of another example embodiment of a wearable computing device for spatial computing interactions.

FIG. 10 is a flow diagram of an example embodiment routine for immersive computing environments and AI interactions using a wearable computing apparatus.

FIG. 11 is a flow diagram of another example embodiment routine for immersive computing environments and AI interactions using a wearable computing apparatus.

FIG. 12A is a flow diagram of an example embodiment of a method for communication between two or more wearable computing apparatuses.

FIG. 12B is a data flow diagram of an example embodiment of a method for communications between two or more wearable computing apparatuses.

### DETAILED DESCRIPTION

Before the present subject matter is described in detail, it is to be understood that this disclosure is not limited to the particular embodiments described herein, as such may, of course, vary. It is also to be understood that the terminology used herein is for the purpose of describing particular embodiments only, and is not intended to be limiting, since the scope of the present disclosure will be limited only by the appended claims.

As used herein and in the appended claims, the singular forms “a,” “an,” and “the” include plural referents unless the context clearly dictates otherwise.

Generally, embodiments of the present disclosure comprise wearable computing devices and/or apparatuses for augmented reality (“AR”), virtual reality (“VR”), artificial intelligence (“AI”) interactions, and/or spatial computing interactions, and systems and methods relating thereto. Accordingly, the embodiments of the present disclosure are wearable computing apparatuses and/or devices configured to be worn on a user's hand. These embodiments generally comprise: (1) a controller portion including, at least, one or more processors; non-transitory memory for storing instructions; at least one haptic motor; and a set of sensors adapted to sense positional characteristics associated with the user's hand; and (2) an accessory portion comprising, at least, a plurality of flexible leads, each of which is configured to attach to a finger of the user's hand, a haptic motor, and a set of sensors adapted to sense a plurality of positional characteristics of the user's fingers. In most embodiments the sensors include accelerometers and gyroscope sensors.

According to another aspect of the embodiments, the wearable computing devices of the present disclosure can include: one or more multicolored LEDs, speakers, a subwoofer, a microphone, and/or an array of ultrasonic transducers.

Additionally, the present disclosure may also include methods steps that make up one or more routines and/or subroutines for facilitating AR, VR, AI, and/or spatial computing interactions. For example, some embodiments disclosed herein include instructions stored in non-transitory memory of the first subassembly that, when executed by the one or more processors, cause the one or more processors to perform routines involving one or more multicolored LEDs, speakers, a subwoofer, a microphone, and/or an array of ultrasonic transducers of the wearable computing device. For each and every embodiment of a method, routine or subroutine disclosed herein, systems and devices capable of performing each of those embodiments are covered within the scope of the present disclosure.

Furthermore, the embodiments of wearable computing apparatuses and/or devices disclosed herein may include wireless communications modules for communicating with remote computing devices, or with a remote server system that is location-independent, i.e., cloud-based. In addition, embodiments of methods for communications between two or more wearable computing apparatuses and/or devices are also described.

The embodiments of the present disclosure provide for improvements over prior modes in the computer-related field of AR, VR, AI, and spatial computing. These improvements may include, for example, the optimization of computer resources (such as processors, memory, and network bandwidth) and improved positional tracking by the use of sensors (such as accelerometers and gyroscopes) on the hand and fingers. These improvements are necessarily rooted in computer-based technologies of augmented reality, virtual reality, and artificial intelligence, and are directed to solving a technological challenge that might otherwise not exist but for the need for computer-based AR, VR and AI interactions. Additionally, many of the embodiments disclosed herein reflect an inventive concept in the particular arrangement and combination of the devices, components and method steps utilized for interacting using AR, VR, AI, and spatial computing technologies. Other features and advantages of the disclosed embodiments are further discussed below.

### Example Embodiments of Wearable Computing Apparatuses for Immersive Computing Environments and AI Interactions

Example embodiments of wearable computing apparatuses for immersive computing environments and AI interactions will now be described, as well as their operation.

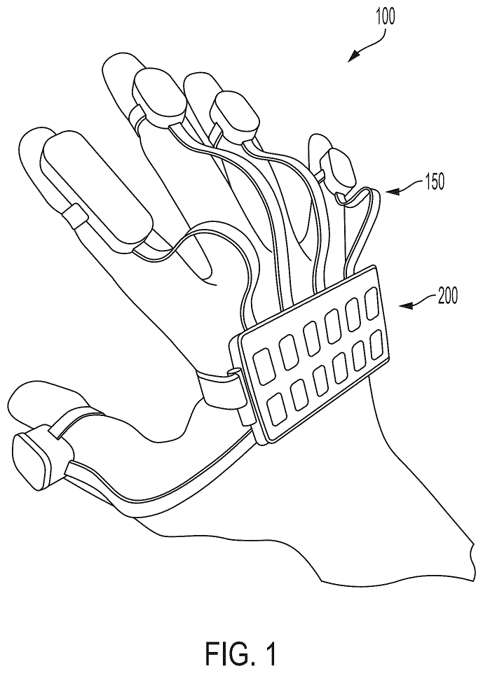

FIG. 1 depicts a perspective view of one example embodiment of a wearable computing apparatus 100 for AR, VR, and AI interactions. As shown in FIG. 1, wearable computing apparatus 100 can be worn on a user's hand and can comprise a first subassembly 200 (also referred to as the controller subassembly) and a second subassembly 150 (also referred to as an accessory subassembly), each of which are described in further detail below. First subassembly 200 can include a top surface having a display disposed thereon. In many of the embodiments, the display can be a touchscreen panel. According to another aspect of the example embodiment, second subassembly 150 can comprise multiple flexible leads, wherein each flexible lead includes a distal portion adapted to be secured to a different finger of the user's hand.

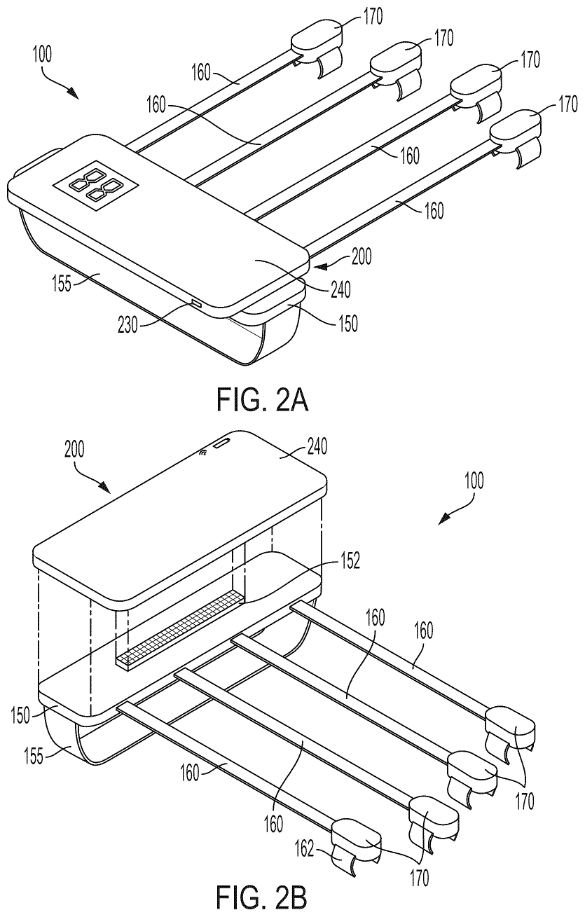

FIGS. 2A and 2B are drawings depicting perspective views of another example embodiment of a wearable computing apparatus 100 for AR, VR, and AI interactions. According to one aspect of the example embodiment, wearable computing apparatus 100 can comprise a first subassembly 200, wherein first subassembly 200 comprises a housing having a top surface, a bottom surface and at least one side surface. In many of the embodiments disclosed herein, a display 240, such as a touchscreen panel, can be disposed on the top surface of first subassembly 200. As can also be seen in FIG. 2A, a micro USB port 230 can be provided on a side surface of first subassembly 200, and configured to allow for charging a rechargeable battery disposed within the housing of first subassembly 200, or for transferring data to or from memory disposed within the housing of first subassembly 200. Although a micro USB port 230 is depicted and described with respect to FIG. 2A, those of skill in the art will also recognize that other physical ports for wired communication and/or charging the rechargeable battery, including but not limited to USB-A, USB-B, USB-C, mini-USB, USB 3, firewire, and/or serial ports, are fully within the scope of the present disclosure.

According to another aspect of the embodiments, wearable computing apparatus 100 can comprise a second subassembly 150, wherein the second subassembly 150 includes an adjustable strap 155 adapted to secure second subassembly 150 to the user's hand. Adjustable strap 155 can be constructed from a material having elastic properties, such as nylon or polyester, in order to attach second subassembly 150 to the user's hand in a secure manner. As shown in FIGS. 2A and 2B, a plurality of flexible leads 160 are also provided, wherein each of the plurality of flexible leads 160 is configured to be removably secured to a finger of the user's hand by a clip 162 or elastic band. In many of the embodiments, each of the flexible leads 160 can include a distal portion 170 which can house a haptic motor (not shown) configured to provide vibratory feedback to each finger, and a set of sensors (not shown) adapted to sense a plurality of positional characteristics associated with the finger to which the flexible lead 160 is secured. In some embodiments, the haptic motors of second subassembly 150 can comprise one or more actuators including, for example, eccentric rotating mass actuators (ERMs), linear resonant actuators (LRAs), and/or high-definition piezoelectric or ceramic haptic actuators. In some embodiments, the sensors can be microelectromechanical (MEMS) devices and can comprise, for example, at least one of an accelerometer for measuring acceleration, including but not limited to single- or three-axis accelerometers, and a gyroscope sensor for measuring rotation and rotational velocity. In other embodiments, the sensors can also include magnetometers for measuring the Earth's magnetic field and a local magnetic field in order to determine the location and vector of a magnetic force, temperature and/or pressure sensors for measuring environmental conditions.

Referring still to FIGS. 2A and 2B, first subassembly 200 can also include a first connector interface (not shown) on a bottom surface configured to communicatively couple the first subassembly 200 to a second connector interface 152 of the second subassembly 150. As best seen in FIG. 2B, first subassembly 200 can thus be coupled with and/or removed from second subassembly 150. According to one aspect of the embodiment, the haptic motor and sensors in distal portions 170 are configured to communicate, send and receive electrical signals with first subassembly 200 through flexible leads 160 via the first and second connector interfaces. Although second connector interface 152 of second subassembly 152 is shown as a female connector, those of skill in the art will recognize that second connector interface 152 can be a male connector or any other type of physical connector configured to mate with the first connector interface of first subassembly 200.

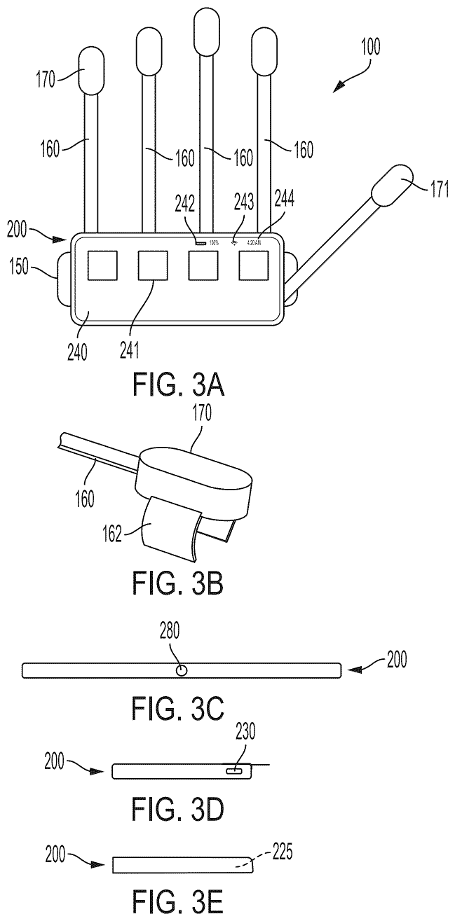

FIG. 3A is a top view of another example embodiment of a wearable computing apparatus 100 for AR, VR, and AI interactions. According to one aspect of the embodiment, a display 240 is disposed on the top surface of first subassembly 200. Display 240 can be a touchscreen panel for visually displaying, for example, graphical icons for various software applications 241 which are stored in memory of first subassembly 200, a battery indicator 242, a wireless connection strength indicator 243, and a date/time display 244. Second subassembly 150, a portion of which is beneath first subassembly 200, as depicted in FIG. 3A, can be removably coupled with first subassembly 200. According to another aspect of the embodiment, second subassembly 150 comprises a plurality of flexible leads 160, wherein each of the plurality of flexible leads is configured to be removably secured to a finger of the user's hand, and wherein each flexible lead includes a distal portion 170 that houses a haptic motor and a set of sensors adapted to sense a plurality of positional characteristics associated with the finger to which distal portion 170 is secured. In some embodiments, second subassembly 150 can include a flexible lead 160 having a distal portion 171 secured to the user's thumb, wherein distal portion 171 also includes a switch or depressible button (not shown) to power on/off wearable computing apparatus 100.

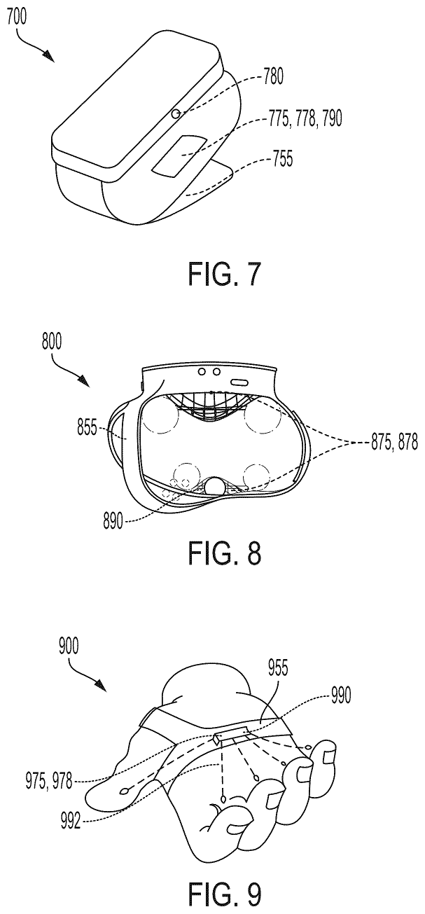

As seen in FIG. 3A, in many of the embodiments disclosed herein, second subassembly 150 can include five flexible leads, each of which is secured to one of the five fingers (including the thumb) of the user's hand. In other embodiments, however, second subassembly 150 can include four flexible leads, each of which is secured to one of four fingers (excluding the thumb), as can be seen in FIGS. 2A and 2B. In still other embodiments, second subassembly 150 can have no flexible leads, such as the embodiments described below with respect to FIGS. 7A to 7E, FIGS. 8A to 8C, and FIG. 9. Those of skill in the art will recognize that embodiments of second subassembly 150 can include any other number of flexible leads 160 (e.g., 1, 2, 3 . . . ), and are fully within the scope of the present disclosure.

FIG. 3B is a perspective view of an example embodiment of a portion of a flexible lead 160 of a wearable computing apparatus 100 for AR, VR, and AI interactions. In many of the embodiments described herein, each flexible lead 160 is configured to be removably secured to a finger of the user's hand by a clip 162 or elastic band. In some embodiments, clip 162 can include a capacitive sensor having, for example, a mutual-capacitance configuration or a self-capacitance configuration, to detect if and/or when a finger has been attached. According to another aspect of the embodiments, flexible lead 160 can Include a distal portion 170 that houses a haptic motor and a set of sensors adapted to sense a plurality of positional characteristics associated with the finger. In some embodiments, one or more distal portions 170, 171 can also include an LED indicator light to indicate when wearable computing apparatus 100 is powered on. The haptic motor and sensors of second subassembly 150, including the capacitive sensor, can be communicatively coupled through the flexible lead 160 to one or more processors disposed in first subassembly 200.

FIGS. 3C, 3D, and 3E are side views of example embodiments of first subassembly 200. Although first subassembly 200 is depicted in the figures as having a rectangular housing, those of skill in the art will recognize that other geometries for the housing of first subassembly 200 are possible and fully within the scope of the present disclosure, including but not limited to, an elliptical, circular, dome-shaped, triangular, square, trapezoidal, hexagonal, or octagonal housing. As can be seen in FIG. 3C, a camera 280 can be disposed on a side surface of first subassembly 200. In some embodiments, camera 280 can be “forward facing,” such that the camera lens is disposed on the side surface closest to the fingers. Furthermore, although a single camera 280 is depicted in the figure, those of skill in the art will appreciate that multiple cameras can be disposed on various surfaces of first subassembly 200.

Turning to FIG. 3D, another side view of an example embodiment of first subassembly 200 is provided, and depicts a micro USB port 230 disposed on a side surface of first subassembly 200. In many of the embodiments, micro USB port 230 can be used for charging a battery (not shown) housed in first subassembly 200 and/or transferring data to and from memory (not shown) housed in first subassembly 200. As described earlier, although a micro USB port 230 is depicted and described with respect to FIG. 3D, those of skill in the art will also recognize that other physical ports for wired communication and/or charging the rechargeable battery, including but not limited to USB-A, USB-B, USB-C, mini-USB, USB 3, firewire, and/or serial ports, are fully within the scope of the present disclosure. In other embodiments, a memory device slot can be disposed of on a side surface of first subassembly 200 in addition to (or instead of) micro USB port 230, wherein the memory device slot is configured to receive a removable memory device or media, such as, for example, a Universal Flash Storage device, a micro SD memory card, an SD memory card, an SDHC memory card, an SDXC memory card, a CompactFlash memory card, or a memory stick.

FIG. 3E is another side view of an example embodiment of first subassembly 200. As indicated by the dashed line, according to one aspect of the embodiments, a Near Field Communication (“NFC”) antenna or module 225 can be disposed just beneath a side surface of first subassembly 200, wherein the NFC antenna or module 225 is coupled to one or more processors of first subassembly 200, and wherein the NFC antenna or module 225 is configured to send and/or receive communications with a remote computing device, such as with a desktop, laptop or mobile computing device, according to a standard NFC communication protocol (e.g., ECMA-340, ISO/IEC 18092, ISO/IEC 21481, etc.).

### Example Embodiment of First Subassembly (Controller Subassembly)

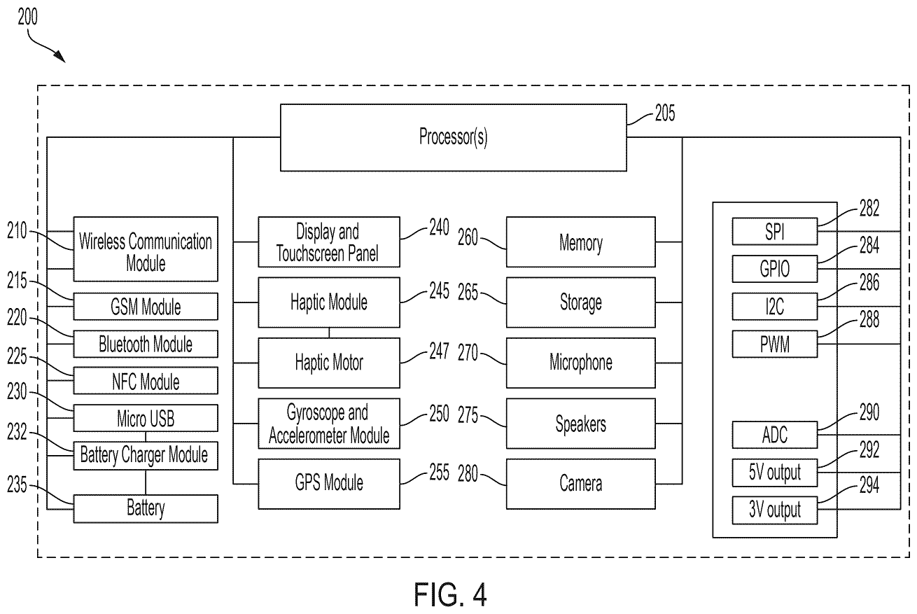

FIG. 4 is a block diagram depicting an example embodiment of the first subassembly 200 (also referred to as the controller subassembly) of wearable computing apparatus 100. In some embodiments, first subassembly 200 can be a microcomputer comprising a plurality of sensors, one or more processors, non-transitory memory, and other circuitry mounted on a single printed circuit board and disposed within a housing. According to one aspect of the embodiments disclosed herein, first subassembly 200 is configured to provide dedicated computing resources, such as processing power, battery power, memory, network bandwidth and mass storage, for facilitating user interactions within an AR and/or VR environment, or for performing AI-enabled interactions.

Referring to FIG. 4, first subassembly 200 may include one or more processors 205, which may comprise, for example, one or more of a general-purpose central processing unit (“CPU”), a graphics processing unit (“GPU”), an application-specific integrated circuit (“ASIC”), a field programmable gate array (“FPGA”), an Application-specific Standard Products (“ASSPs”), Systems-on-a-Chip (“SOCs”), Programmable Logic Devices (“PLDs”), or other similar components. Furthermore, processors 205 may include one or more processors, microprocessors, controllers, and/or microcontrollers, or a combination thereof, wherein each component may be a discrete chip or distributed amongst (and a portion of) a number of different chips, and collectively, may have the majority of the processing capability for performing routines to facilitate user interactions with AR and VR environments, for performing AI-enabled interactions, as well as for performing other routines. In many embodiments, first subassembly 200 may also include one or more of the following components, each of which can be coupled to the one or more processors 205: memory 260, which may comprise non-transitory memory, RAM, Flash or other types of memory; mass storage devices 265; a battery charger module 232; a rechargeable battery 235; a display module 240 coupled with a touchscreen panel; a haptic module 245 coupled to one or more haptic motors 247 for providing vibratory/tactile feedback; a gyroscope and accelerometer module 250; a GPS (Global Positioning System) module 255; a microphone 270 for receiving voice input and/or voice commands; one or more speakers 275; and a camera 280. According to some of the embodiments disclosed herein, haptic motors 247 can comprise one or more actuators including, for example, eccentric rotating mass actuators (ERMs), linear resonant actuators (LRAs), and/or high-definition piezoelectric or ceramic haptic actuators. In some embodiments, first subassembly 200 can also include a removable memory device, such as a Universal Flash Storage device, a micro SD memory card, an SD memory card, an SDHC memory card, an SDXC memory card, a CompactFlash memory card, or a memory stick.

In addition, in some embodiments, gyroscope and accelerometer module 250 can include one or more accelerometers for measuring acceleration, including but not limited to single- or three-axis accelerometers; magnetometers for measuring the Earth's magnetic field and a local magnetic field in order to determine the location and vector of a magnetic force; gyroscope sensors for measuring rotation and rotational velocity; or any other type of sensor configured to measure the velocity, acceleration, orientation, and/or position of first subassembly 200. In other embodiments, gyroscope and accelerometer module 250 can also include temperature and pressure sensors for measuring environmental conditions. In many of the embodiments, gyroscope and accelerometer module 250 can comprise microelectromechanical (MEMS) devices.

According to another aspect of the embodiments, first subassembly 200 can further include one or more of the following components, each of which can be coupled to the one or more processors 205, for communicating with a remote computing system (not shown), such as a laptop or desktop computer and/or a mobile computing device, according to a standard wireless networking protocol, such as 802.11x, Bluetooth, Bluetooth Low Energy, or Near Field Communication (NFC): a wireless communications module 210; a GSM (Global System for Mobile communication) module 215; a Bluetooth or Bluetooth Low Energy module 220; an NFC (Near Field Communication) module 225. In some embodiments, first subassembly 200 can include a micro USB module/port 230, which can comprise a port which can be used to charge rechargeable battery 235, transfer data to and from the remote computing system, or attach a peripheral device such as a keyboard or memory device to upload, configure, or upgrade software or firmware on first subassembly 200. Although a micro USB port 230 is depicted and described, those of skill in the art will also recognize that other physical ports for wired communication and/or charging the rechargeable battery, including but not limited to USB-A, USB-B, USB-C, mini-USB, USB 3, firewire, and/or serial ports, are fully within the scope of the present disclosure. Those of skill in the art will further recognize that other standard wired and/or wireless networking protocols are within the scope of the present disclosure.

According to still another aspect of the embodiments, first subassembly 200 can further include one or more of the following components and/or interfaces, each of which can be coupled to the one or more processors 205, for communicating and/or interfacing with a second subassembly 150 (also referred to as an accessory subassembly): an SPI (Serial Peripheral Interface) interface 282; a GPIO (General-purpose input/output) interface 284; an I²C (Inter-integrated Circuit) interface 286; a PWM (Pulse Width Modulation) interface 288; an analog to digital converter module 290 configured to convert an analog signal received from one or more sensors into a digital signal; and 5V and 3V output interfaces 292, 294 to provide power to second subassembly 150.

As understood by one of skill in the art, the aforementioned components and others of the first subassembly are electrically and communicatively coupled in a manner to make a functional device.

### Example Embodiments of Wearable Computing Apparatus and Routines for AI Interactions

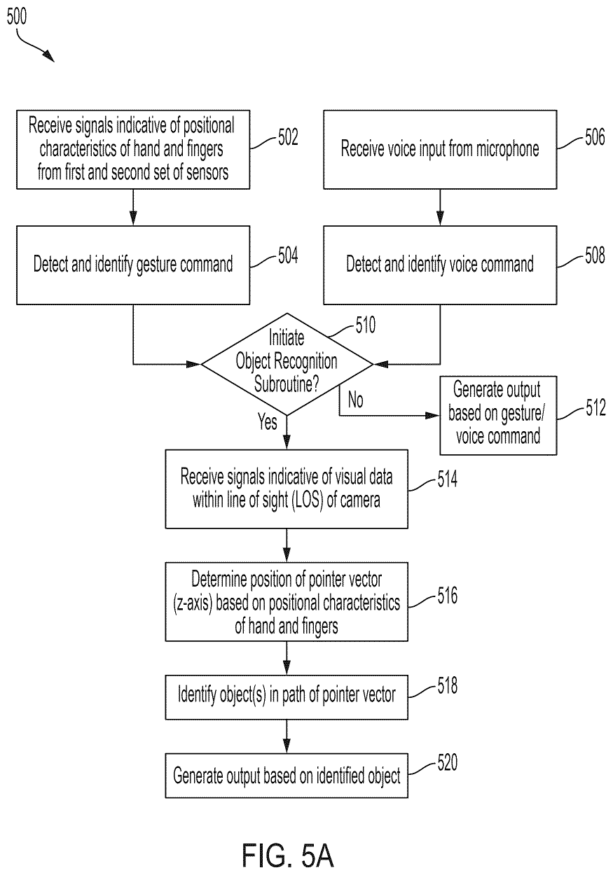

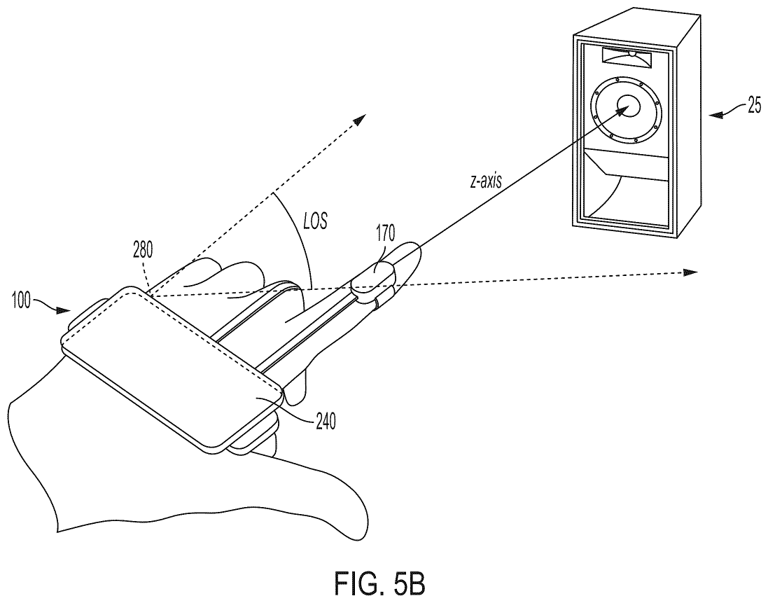

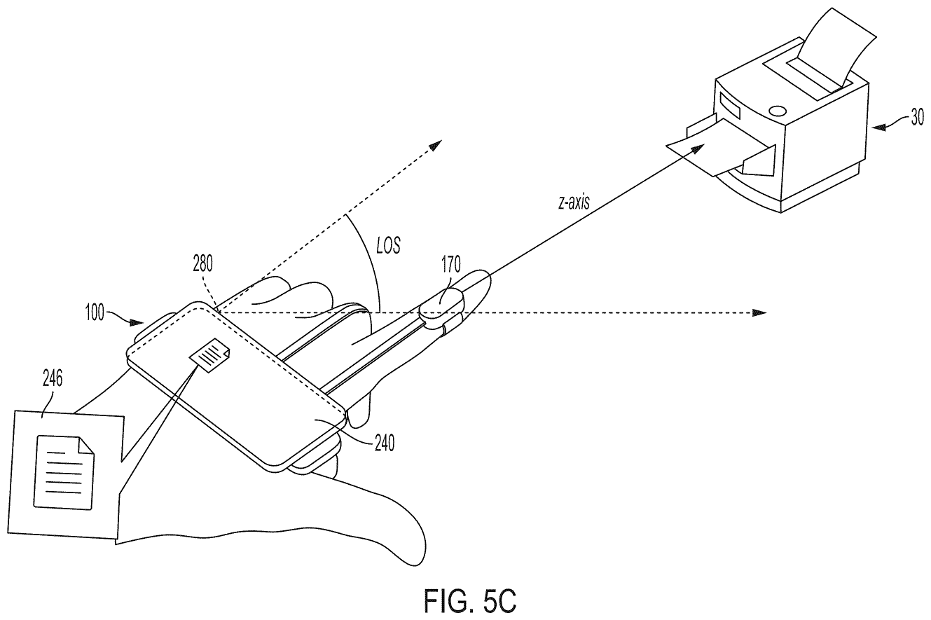

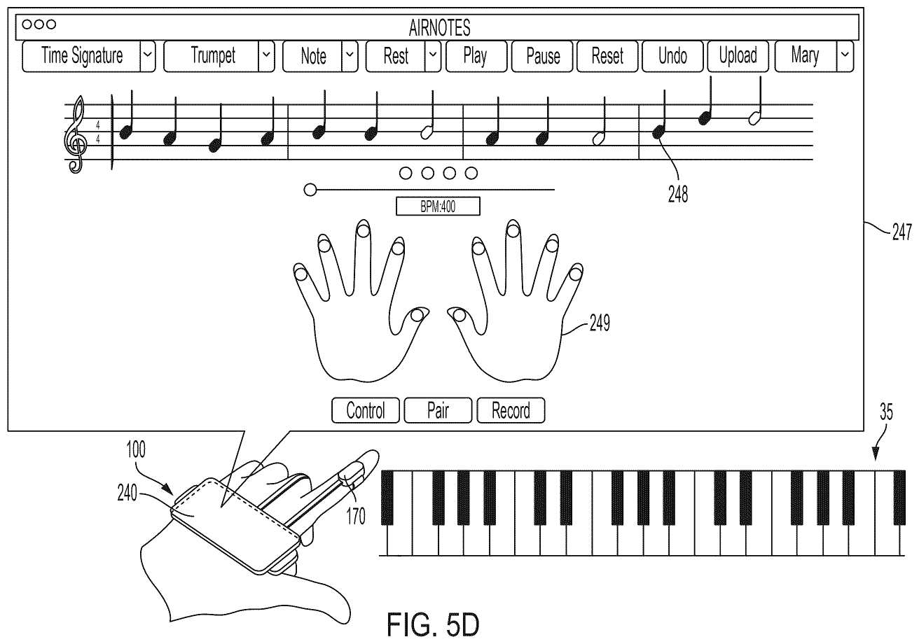

FIG. 5A is a flow diagram of an example embodiment of a method/routine 500 performed by wearable computing apparatus 100 for AR, VR, and AI interactions. Generally, according to one aspect of the embodiment, wearable computing apparatus 100 can be configured to perform certain routines which can include, for example, object recognition subroutines, voice control subroutines, gesture recognition subroutines, and combinations thereof. Furthermore, those of skill in the art will understand that the routines and subroutines described herein comprise instructions stored in a non-transitory memory of the first subassembly (also referred to as the controller subassembly) which, when executed by one or more processors, cause the one or more processors to perform the method steps of the described routines and subroutines.

Turning to FIG. 5A, method 500 can be initiated at Step 502, wherein wearable computing apparatus 100 receives signals indicative of the positional characteristics of the hand and fingers from the sensors in the first and second subassembly. As described earlier, the first subassembly can include gyroscope sensors and accelerometers to sense positional characteristics of the hand. Similarly, the second subassembly can include gyroscope sensors and accelerometers housed in the distal portion of each flexible lead to sense positional characteristics of each finger. At Step 504, wearable computing apparatus 100 can detect a predefined gesture command based on the positional characteristics of the hand and fingers. In some of the embodiments disclosed herein, for example, the predefined gesture command can be a pointed index finger. In other embodiments, the predefined gesture command can be a pinching motion between the index finger and thumb. Those of skill in the art will recognize that other gestures can be utilized, and are fully within the scope of the present disclosure.

At Step 510, based upon the predefined gesture, wearable computing apparatus 100 determines whether an object recognition subroutine should be initialized. If the predefined gesture does not call for an object recognition subroutine then, at Step 512, wearable computing apparatus 100 generates a predefined output based on the gesture command. For example, wearable computing apparatus 100 can include instructions stored in non-transitory memory for a routine for telling the current time, wherein the routine can include a gesture recognition subroutine, and wherein the predefined gesture command has been defined as drawing a circle in the air with the index finger (“draw circle gesture”). According to one aspect of the embodiment, if the “draw circle gesture” is detected at Step 504, then wearable computing apparatus 100 can visually output the current time on its display or output an audio indication of the current time.

Referring still to FIG. 5A, some embodiments of method 500 can include a voice control subroutine, which can be initiated at Step 506, and wherein wearable computing apparatus 100 receives voice input from the microphone. As described earlier with respect to FIG. 4, first subassembly of wearable computing apparatus 100 can include a microphone. Those of skill in the art will appreciate that a microphone can also be housed in one of the distal portions of the flexible leads of the second subassembly, and used for voice input. At Step 508, wearable computing apparatus 100 can detect a predefined voice command based on the voice input received from the microphone. At Step 510, based upon the predefined voice command, wearable computing apparatus 100 determines whether an object recognition subroutine should be initialized. If the predefined voice command does not call for an object recognition subroutine then, at Step 512, wearable computing apparatus 100 generates a predefined output based on the voice command.

Similar to the previous embodiment, wearable computing apparatus 100 can include instructions stored in non-transitory memory for a routine for telling time, wherein the routine can include a voice command subroutine, and wherein the predefined voice command has been defined as the spoken words: “Ola, what time is it?” According to one aspect of the embodiment if the voice command “Ola, what time is it?” is detected by the microphone, then wearable computing apparatus 100 can visually output the current time on its display or output an audio indication of the current time.

According to some embodiments, method 500 can also include one or more object recognition subroutines. Referring still to FIG. 5A, at Step 514, after the object recognition subroutine has been initiated, wearable computing apparatus 100 receives signals indicative of visual data within the line of sight (LOS) of the camera. In many of the embodiments, the signals can be video signals. In other embodiments, the signals can comprise infrared images. At Step 516, wearable computing apparatus 100 can determine a pointer vector (shown as the z-axis in FIG. 5B), based on a predefined gesture, such as a user pointing the index finger, and the positional characteristics of the user's hands and fingers. At Step 518, wearable computing apparatus 100 can identify one or more objects in the path of the pointer vector. At Step 520, wearable computing apparatus 100 can generate a predetermined output according to the identified object or objects.

Turning to FIG. 5B, an example routine for playing music on an output device, such as a speaker, is depicted, wherein the routine comprises a combination of, at least, a gesture recognition subroutine and an object recognition subroutine. In particular, a user makes a gesture while wearing wearable computing apparatus 100, wherein the gesture comprises pointing the user's index finger at an object. A gesture subroutine detects a “finger pointing” gesture, and in response thereto, initiates an object recognition subroutine associated with the “finger pointing” gesture. The object recognition subroutine can then cause wearable computing apparatus 100 to receive a plurality of signals indicative of visual data within a line of sight (“LOS”) of camera 280, in order to determine a pointer vector (z-axis) based on sensor data received from the sensors disposed in the distal portion 170 of flexible lead attached to the index finger, and to identify the object (in this case, speaker 25) in the path of the pointer vector. In some embodiments, wearable computing apparatus 100 can provide a visual notification on display 240 and/or or tactile feedback via the one or more haptic motors of the first or second subassembly, to confirm that speaker 25 has been successfully identified. In response to identifying speaker 25, wearable computing apparatus 100 can perform one or more of the following output steps: initiate a music app on wearable computing apparatus 100, display a graphical user interface (GUI) for a music app on display 240, establish a wireless communications channel with speaker 25, such as a Bluetooth connection; and/or output audio to speaker 25. Those of skill in the art will further appreciate that any combination of the aforementioned steps is fully within the scope of the present disclosure. For example, a similar method for using a gesture recognition subroutine and an object recognition subroutine can be utilized to open and play a television app.

Turning to FIG. 5C, an example routine for printing a document is depicted, wherein the routine can comprise a combination of one or more gesture recognition subroutines, a voice control subroutine and/or an object recognition subroutine. According to one aspect of the disclosed embodiments, the routine can be initiated when a user selects a document icon 246 on the touchscreen panel 240 of wearable computing apparatus 100. In some embodiments, the routine can be initiated when a user issues a voice command (such as “Ola, print selected document”). In other embodiments, the user can perform a first predefined gesture, such as, for example, grabbing a “virtual” document icon displayed in augmented reality on the touchscreen panel 240. A gesture subroutine detects the “grabbing” gesture, and in response thereto, selects the appropriate document. Subsequently, the user can perform a second predefined gesture, wherein the second predefined gesture comprises pointing the user's index finger at an object. The gesture subroutine detects a “finger pointing” gesture, and in response thereto, initiates an object recognition subroutine associated with the “finger pointing” gesture. In other embodiments, the predefined gesture may comprise “dragging” the selected document to an object in real life. The object recognition subroutine can then cause wearable computing apparatus 100 to receive a plurality of signals indicative of visual data within a line of sight (“LOS”) of camera 280, in order to determine a pointer vector (z-axis) based on sensor data received from the sensors disposed in the distal portion 170 of flexible lead attached to the index finger, and to identify the object (in this case, printer 30) in the path of the pointer vector. In some embodiments, wearable computing apparatus 100 can provide a visual notification on display 240 and/or or tactile feedback via the one or more haptic motors of the first or second subassembly, to confirm that printer 30 has been successfully identified. In response to identifying printer 30, wearable computing apparatus 100 can cause the selected document to print to printer 30. In some embodiments, a graphical user interface (GUI) for printing can also be shown on display 240. Those of skill in the art will further appreciate that any combination of the aforementioned steps is fully within the scope of the present disclosure.

Referring to FIGS. 5B and 5C, “target” objects, such as a speaker system or a printer device, are depicted and described in operation with the example routines and subroutines of method 500. However, those of skill in the art will appreciate that other objects can also be incorporated for use with these example routines and subroutines of method 500. For example, in some embodiments, the steps of the example routines and subroutines of method 500, as described with respect to FIG. 5A, can be performed with respect to a visual display (e.g., television or computer screen) to cause the visual display to output desired visual and audio content. In other embodiments, the steps of the example routines and subroutines of method 500, as described with respect to FIG. 5A, can be performed with respect to an unmanned aerial vehicle (i.e., UAV or drone) to cause the UAV to move in a desired direction. In still other embodiments, the steps of the example routines and subroutines of method 500 can be performed with respect to one or more robotic arms, to cause the one or more robotic arms to move in a desired manner. These examples are meant to be illustrative only, as those of skill in the art will appreciate that other objects and devices to be controlled according to the example routines and subroutines of method 500 are within the scope of this disclosure, and are not limited in any way to the examples described herein.

Turning to FIG. 5D, an example routine for instructing a user on how to play a musical instrument is depicted, wherein the routine can comprise a combination of one or more gesture recognition subroutines. According to one aspect of the disclosed embodiments, the routine can be initiated when a user launches a musical instrument interface 247 from the touchscreen panel 240 of wearable computing apparatus 100. Subsequently, a sequence of musical notes 248 can be visually displayed on interface 247, along with a graphical representation of user's hands and fingers 249. According to one aspect of the embodiments, a haptic motor housed in a distal portion 170 of a flexible lead can provide a vibratory indication to the user to designate the correct finger to play the next note from the sequence of musical notes 248. In some embodiments, a LED indicator light can also simultaneously provide a visual indication to the user to designate the correct finger to play the next note from the sequence of musical notes 248. In other embodiments, a gesture subroutine can track the motion of each finger and provide visual, auditory and/or vibratory feedback in response to an incorrect movement.

Referring still to FIG. 5D, according to another aspect of the disclosed embodiments, an example routine for composing a musical piece is provided, wherein the routine can comprise a combination of one or more gesture recognition subroutines. As with the previous embodiment, the routine can be initiated when a user launches a musical instrument interface 247 from the touchscreen panel 240 of wearable computing apparatus 100. Subsequently, a user can select a “record mode” from interface 247. According to one aspect of the embodiments, wearable computing apparatus 100 can utilize the microphone housed in first subassembly to detect and identify each note being played by user. Furthermore, in some embodiments, a gesture subroutine can detect the finger played, and correlate the finger with each detected audio note. Subsequently, a sequence of musical notes 248 can be constructed and stored in memory of wearable computing apparatus 100. Those of skill in the art will further appreciate that any combination of the aforementioned steps is fully within the scope of the present disclosure.

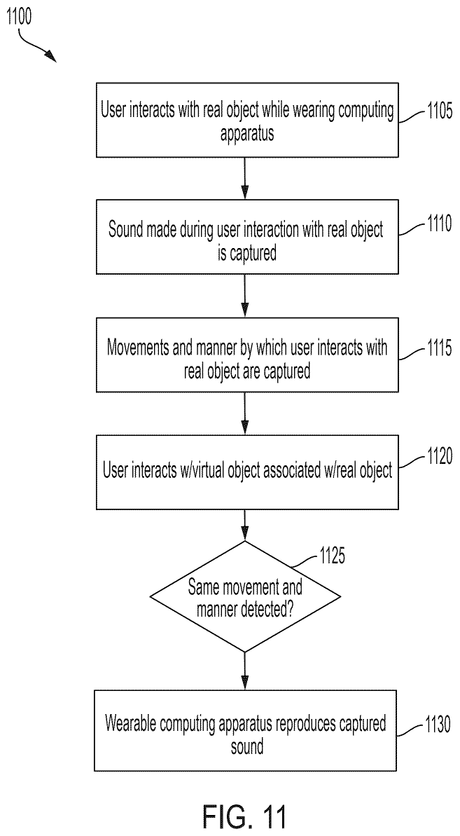

According to another embodiment (not shown), another example routine for instructing a user on how to play a musical instrument can comprise a first wearable computing apparatus 100A, to be worn by an instructor, and a second wearable computing apparatus 100B, to be worn by a student. (Additional details regarding example embodiments of methods for communications between two or more wearable computing apparatuses are further described below with respect to FIGS. 11A and 11B.) According to one aspect of the embodiment, the instructor can play a first musical instrument while wearing first wearable computing apparatus 100A, which can include one or more sensors that are configured to detect movement of the instructor's hand and fingers, while the instructor is playing the first musical instrument, and generate one or more data signals in response thereto. Subsequently, first computing apparatus 100A, which can also include a wireless communication module, transmits the one or more data signals to the second wearable computing apparatus 100B, worn by the student. According to some embodiments, the transmission of the one or more data signals from first wearable computing apparatus 100A to second wearable computing apparatus 100B can comprise either wired or wireless communications, such as, e.g., according to a wireless communication protocol (e.g., Bluetooth, Wi-Fi, infrared, etc.). According to another aspect of the embodiment, wearable computing apparatus 100B can include a wireless communication module for receiving the transmitted one or more data signals, one or more processors, memory coupled to the one or more processors, and one or more haptic motors. Upon receiving the one or more data signals, the processors of wearable computing apparatus 100B can execute instructions stored in memory that cause the one or more haptic motors to output a vibratory signal.

For example, according to some embodiments, if the instructor plays a note with his index finger of the right hand, on which wearable computing apparatus 100A is worn, the one or more sensors of wearable computing apparatus 100A detect the movement of the index finger of the instructor's right hand, generate one more data signals corresponding to the movement, and transmits, with a wireless communication module of wearable computing apparatus 100A, the one or more data signals to wearable computing apparatus 100B, worn by the student. Subsequently, wearable computing apparatus 100B receives, by a wireless communication module of wearable computing apparatus 100B, the one or more data signals. Subsequently, instructions stored in memory of wearable computing apparatus 100B are executed to cause one or more haptic motors to generate a vibratory output to the index finger of the student's right hand. In some embodiments, wearable computing apparatus 100B can also include instructions stored in memory which, when executed by the one or more processors, cause a visual output to a display of wearable computing apparatus 100B. The visual output can include, for example, a graphical representation of user's hands and fingers, as shown in FIG. 5D. In still other embodiments, an LED indicator light can also simultaneously provide a visual indication to the user to designate the correct finger to play the next note from the sequence of musical notes, as described with respect to FIG. 5D. Those of skill in the art will appreciate that the various visual and vibratory outputs described herein can be utilized either individually or, optionally, simultaneously to maximize the stimulus received by the student.

Furthermore, although a keyboard is depicted in FIG. 5D, those of skill in the art will appreciate that other musical instruments are within the scope of the present disclosure. For example, in some embodiments, the example routines described herein can be performed with a saxophone, guitar, or violin, among others. The specific instruments described herein and with respect to FIG. 5D are meant to be illustrative only, and not meant to be limiting in any way.

### Example Embodiments of Wearable Computing Devices for Spatial Computing Interactions

Example embodiments of wearable computing devices for spatial computing interactions, and their respective operations, will now be described.

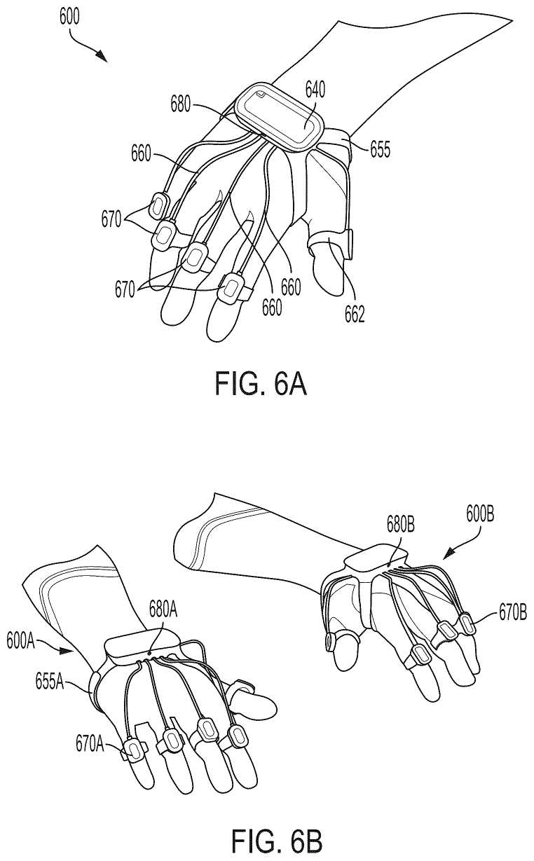

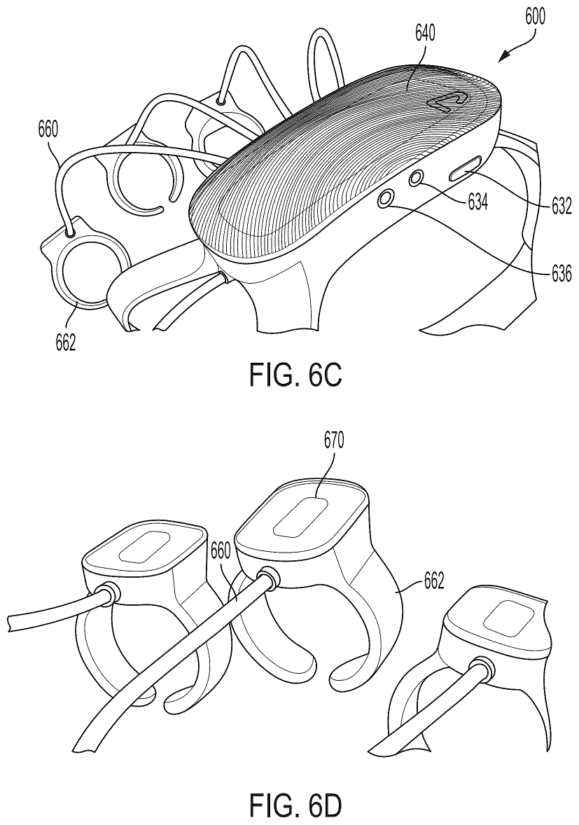

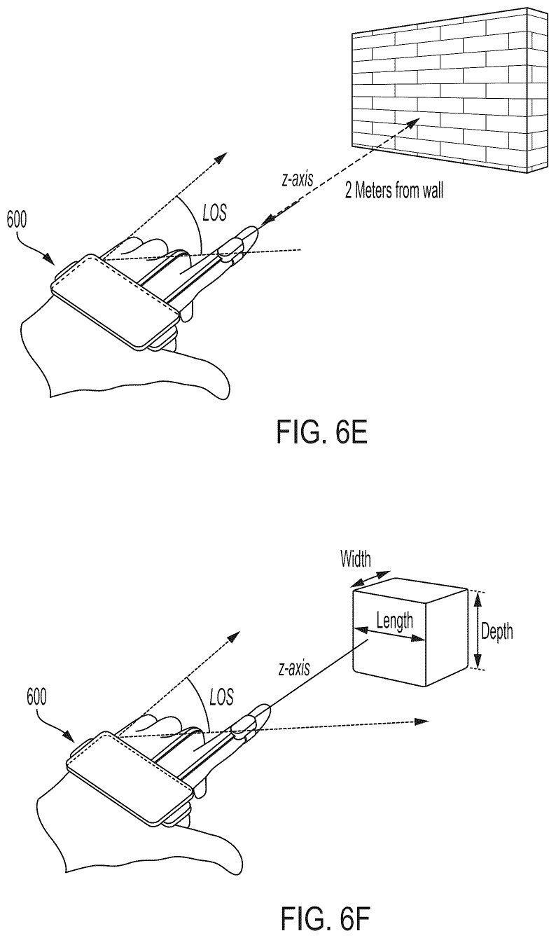

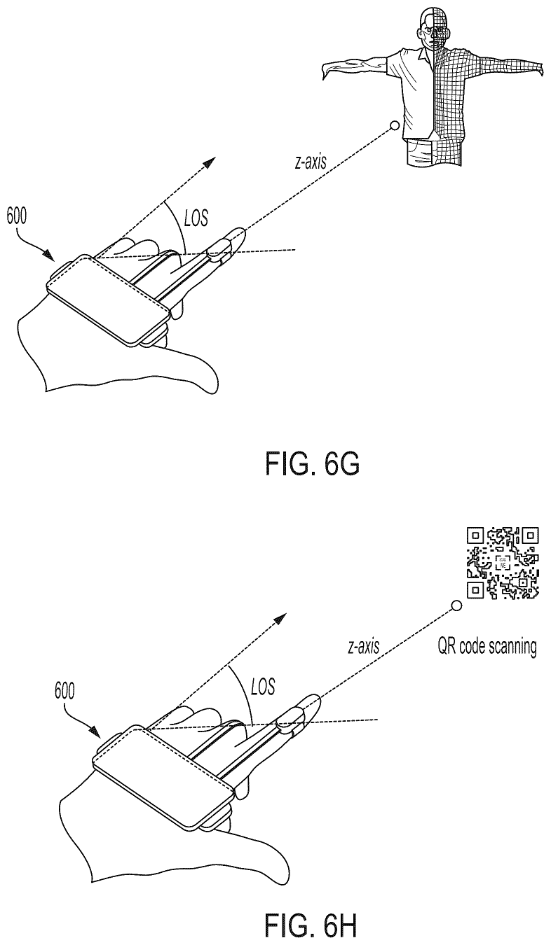

FIGS. 6A to 6D depict an example embodiment of an integrated wearable computing device 600 for spatial computing interactions. According to one aspect of some embodiments, wearable computing device 600 can comprise an integrated form factor, in that it does not have a first subassembly coupled with a second subassembly via a connector interface, as described with respect to some of the earlier embodiments. Still, integrated wearable computing device 600 is similar to wearable computing apparatus 100 (as described with respect to FIGS. 1, 2A to 2B, and 3A to 3E) in several regards. For example, as depicted in FIG. 6A, integrated wearable computing device 600 includes: a controller portion having a display 640; an adjustable strap 655 configured to couple wearable computing device 600 with a user's hand; and, a plurality of flexible leads 660, wherein each of the plurality of flexible leads 660 is configured to be removably secured to a finger of the user's hand by a clip 662 or elastic band. In some embodiments, display 640 can be a touchscreen. In other embodiments, display 640 can include one or more multicolor light-emitting diodes (“LEDs”). In many of the embodiments, each of the flexible leads 660 can include a distal portion 670, wherein each distal portion 670 can house one or more multicolored LEDs. According to some embodiments, display 640 and distal portions 670 can each comprise a translucent material configured to allow light to pass through.

In some embodiments, each of distal portions 670 can also house a haptic motor (not shown) configured to provide vibratory feedback to each finger. Further, in many embodiments, integrated wearable computing device 600 can include one or more cameras 680 on a surface of the controller portion.

In some embodiments, the one or more cameras 680 can include a depth camera accompanied by a time-of-flight (“TOF”) sensor configured for three-dimensional scanning. According to one aspect of some embodiments, a camera in combination with a TOF sensor can be configured to acquire spatial information regarding a user's surroundings or a target object.

For example, according to some embodiments, the one or more cameras 680 in combination with a TOF sensor can be configured to measure a distance of a user's hand from a target object, as shown in FIG. 6E. Using this feature, for example, a visually impaired person could navigate a room similarly to how they would use a cane. In particular, a wearable computing device 600 could vibrate when the user was rapidly approaching or about to collide with an object, about to reach a predetermined boundary of a designated area of safety, or otherwise enter a dangerous or undesirable area, based on 3D data of their surroundings.

According to another aspect of some embodiments, the one or more cameras 680 of wearable computing device 600 in combination with a TOF sensor can be configured to scan a three-dimensional object to obtain geometric characteristics of that object. For example, as shown in FIG. 6F, in some embodiments, a user can point wearable computing device 600 at a box, and the wearable computing device 600 can obtain the height, the width, and the length of the box. Similarly, as another example, a user can point wearable computing device 600 at a cylindrical object, and the wearable computing device 600 can obtain a volume of the cylindrical object. As another example, a user can point wearable computing device 600 at another individual to obtain the other individual's body measurements, as shown in FIG. 6G. Those of skill in the art will understand that other geometric characteristics and/or structural data of an object can be obtained, and all are within the scope of the present disclosure.

According to another aspect of some embodiments, the one or more cameras 680 of wearable computing device 600 in combination with a TOF sensor can be configured to scan a three-dimensional object to obtain structural data associated with the object. Thereafter, the obtained structural data can be used to create a 3D-printed replica of the object. Similarly, the obtained structural data can be used to create a graphical rendering of the object, or even a virtual object, using 3D software.

According to another aspect of some embodiments, the one or more cameras 680 of wearable computing device 600 in combination with a TOF sensor can be configured to identify 3D objects and/or to compare 3D objects with other objects based on their structure. For example, in some embodiments, a user can point wearable computing device 600 at an object to obtain its geometric characteristics and/or structural data. Then, according to some embodiments, the obtained data can be compared against other data stored in memory (e.g., a database) to determine if there is another object that has the same or similar geometric characteristics and/or structural data. As another example, a user can point wearable computing device 600 at a first box to determine if it has the same dimensions as a second box. As another example, a user can point wearable computing device 600 at another individual's face to obtain structural data in order to identify the individual.

According to another aspect of some embodiments, the one or more cameras 680 of wearable computing device 600 can be configured to scan a barcode or QR code, as shown in FIG. 6H. For example, in some embodiments, a user can point wearable computing device 600 at a barcode which will then cause wearable computing device 600 to scan the barcode.

In some embodiments, the one or more cameras 680 can be “forward facing,” such that a camera lens is disposed on a side surface closest to the user's fingers. In other embodiments, the one or more cameras 680 can be disposed on a palm portion of integrated wearable computing device 600. In still other embodiments, the one or more cameras 680 can be disposed on a strap portion of device 600. Although a single camera 680 is depicted in FIG. 6A, those of skill in the art will appreciate that multiple cameras can be disposed on various surfaces of integrated wearable computing device 600.

FIG. 6B depicts a first integrated wearable computing device 600A and a second integrated wearable computing device 600B, wherein each of the devices 600A, 600B is configured to be worn on the user's right hand and the left hand, respectively. Furthermore, each device 600A, 600B can respectively include a plurality of distal portions 670A, 670B, adjustable strap 655A, 655B, and one or more cameras 680A, 680B.

FIG. 6C is a bottoms-up perspective view of integrated wearable computing device 600. As described earlier with respect to FIG. 6A, integrated wearable computing device 600 can include a controller portion having a display 640. According to another aspect of some embodiments, integrated wearable computing device 600 can also include, disposed on a side surface: a power switch 632; a TOF sensor configured to measure distance and to track an appendage of the user (e.g., the user's arm); and a depth camera 636 also configured to track an appendage of the user. In some embodiments, depth camera 636 can be disposed on a side surface that is opposite to the side surface having the front facing camera 680. In other embodiments, cameras 636 and 680 can be disposed on the same side surface of the controller portion.

Although not shown, in some embodiments, integrated wearable computing device can further include a port (e.g., micro USB, USB-A, USB-C, USB-C, mini USB, USB 3, firewire, and/or serial ports) disposed on a side surface configured for charging a battery housed in the controller portion. In other embodiments, a memory device slot (not shown) can be disposed of on a side surface of controller portion in addition to (or instead of) the port, wherein the memory device slot is configured to receive a removable memory device or media, such as, for example, a Universal Flash Storage device, a micro SD memory card, an SD memory card, an SDHC memory card, an SDXC memory card, a CompactFlash memory card, or a memory stick. In still other embodiments, controller unit can include an NFC antenna or module beneath a side surface, wherein the NFC antenna or module is configured to send and/or receive communications with a remote computing device, such as with a desktop, laptop or mobile computing device, according to a standard NFC communication protocol.

Referring still to FIG. 6C, a plurality of flexible leads 660 is shown, each of which is configured to interconnect the controller portion with the plurality of distal portions 670 of integrated wearable computing device 600. In some embodiments, each flexible lead 660 can comprise a cable. In other embodiments, each flexible lead 660 can light up and change colors. As can be seen in FIG. 6D, each of the plurality of flexible leads 660 terminates at a corresponding distal portion 670, which can include a finger strap or clip 662 to couple the distal portion 670 to a finger of the user. In some embodiments, clip 662 can include a capacitive sensor having, for example, a mutual-capacitance configuration or a self-capacitance configuration, to detect if and/or when a finger has been attached.

Referring now to FIG. 6D, as described above, each distal portion 670 can include one or more multicolored LEDs, a haptic motor, and a set of sensors adapted to sense a plurality of positional characteristics associated with the finger. The multicolored LEDs, haptic motor, and sensors of distal portions 670, as well as the capacitive sensor of clip 662, can all be communicatively coupled through the flexible lead 660 to one or more processors disposed in the controller portion of integrated wearable computing device 600.

FIGS. 7 to 9 are additional example embodiments of wearable computing devices for spatial computing interactions. Referring first to FIG. 7, a perspective view is provided of a wearable computing device 700 comprising a camera 780 disposed on a side surface of a controller portion. According to one aspect of the embodiments, wearable computing device 700 includes an adjustable strap 755 configured to couple wearable computing device 700 with a user's hand. Furthermore, disposed on a portion of adjustable strap 755 that is configured to contact the user's palm, are one or more speakers 775, a subwoofer 778, and one or more ultrasonic transducers 790 configured to generate ultrasonic energy.

FIG. 8 is a side view of an integrated wearable computing device 800, comprising an adjustable strap 855 configured to couple device 800 with a user's hand. According to an aspect of the embodiments, integrated wearable computing device 800 can include one or more speakers 875 and/or subwoofers 878 disposed: (i) on a portion of adjustable strap 855 configured to contact the user's palm, and/or (ii) on a portion of adjustable strap 855 configured to contact the back of the user's hand. According to an aspect of the embodiments, due to the proximity to the user's skin, speakers 875 and subwoofer 878 can be configured to provide both audio and haptic feedback to the user. According to another aspect of the embodiments, integrated wearable computing device 800 includes an array of ultrasonic transducers 890 disposed on adjustable strap 855. As shown in FIG. 8, ultrasonic transducers 890 can be disposed on a portion of adjustable strap 855 close to the user's palm. Furthermore, according to some embodiments, ultrasonic transducers 890 form an array configured to emit ultrasonic energy onto the user's hand and fingers to simulate force and touch in the presence of virtual objects on the user's palm.

FIG. 9 is a partial view of a wearable computing device 900, comprising an adjustable strap 955 configured to couple device 900 with a user's hand. According to an aspect of the embodiments, wearable computing device 900 includes one or more speakers 975, subwoofers 978, and ultrasonic transducers 990 disposed on a portion of adjustable strap 955 close to the user's palm. According to another aspect of the embodiments, ultrasonic transducers 990 form an array that is configured to emit ultrasonic beams 992 onto the user's hand and fingers to simulate force and touch in the presence of virtual objects on the user's palm.

It will be understood by those of skill in the art that each of the components and features of the various embodiments described herein (e.g., multicolored LEDs, speakers, subwoofers, and ultrasonic transducers) are not intended to be limited to a specific embodiment or embodiments and are freely combinable.

### Example Use Cases for Multicolored LEDs, Speakers, Subwoofers, and Microphones in Wearable Computing Devices for Spatial Computing Interactions

Example use cases for multicolored LEDs, speakers, subwoofers, and microphones in wearable computing devices for spatial computing interactions will now be described. As an initial matter, it will be understood by those of skill in the art that any of the use cases described herein can take the form of software instructions stored in a memory of the wearable computing device, the memory being coupled with one or more processors of the wearable computing device, and wherein the software instructions, when executed by the one or more processors of the wearable computing device, cause the one or more processors to perform any or all of the specific steps or routines of the use cases described herein.

According to one aspect of the embodiments, the multicolored LEDs disposed in the controller portion and/or distal portions 670 of integrated wearable computing device 600 can provide several functions. As one example, in some embodiments, the multicolored LEDs can increase the visual appeal of integrated wearable computing device 600 by changing the color of the integrated wearable computing device 600 to a preferred color of the user.

According to some embodiments, one or more multicolored LEDs can be used to indicate battery life of the integrated wearable computing device 600 to the user. For example, in some embodiments, one or more multicolored LEDs can blink red, either in the controller portion of integrated wearable computing device 600, distal portions 670, or both, when the remaining battery life of integrated wearable computing device 600 is low.

According to some embodiments, multicolored LEDs can be used to indicate when a first integrated wearable computing device 600A is in a ready-to pair (or “pairing state”) or already wirelessly paired (e.g., via Bluetooth or Wi-Fi) with another device, such as, for example, a second integrated wearable computing device 600B (as shown in FIG. 6B), or with any another electronic or computing device.

In some embodiments, the multicolored LEDs can be used to suggest a movement to a user. For example, according to some embodiments, a green light can be displayed on a particular distal portion 670 to indicate to the user which finger to move when playing a musical instrument. Similarly, a red light can be displayed on a particular distal portion 670 to indicate to the user that an incorrect finger was moved. Those of skill in the art will recognize that these features can be combined with the embodiment described with respect to FIG. 5D.

According to still other embodiments, multicolored LEDs can be used to provide information about a real or virtual object when a user interacts with it. In some embodiments, for example, one or more multicolored LEDs can turn a predetermined color (e.g., blue, red, orange, green) when a user touches or otherwise interacts with a particular object. The changing of the color can be based on a predetermined condition. As one example, in some embodiments, the one or more multicolored LEDs can be used to indicate force or pressure when a user interacts with either a real or virtual object. As yet another example, the one or more multicolored LEDs can be used to indicate a temperature of an object. For example, in some embodiments, when a user touches a “cold” virtual object, one or more multicolored LEDs either in the controller portion of assembly 600, distal portions 670, or both, can turn blue. Similarly, one or more multicolored LEDs either in the control portion of assembly 600, distal portions 670, or both can turn red if the user touches a “hot” virtual object.

According to some embodiments, wearable computing apparatuses 700, 800, 900 can include embedded speakers and subwoofers in combination with haptic motors to simulate the feeling of touch when a user interacts with an object or, in addition to or in lieu of, to simply play music. In some embodiments, sound in combination with multicolored LEDs can be used to make the music listening experience more enjoyable for the user. For example, in some embodiments, the wearable computing apparatus can be configured to change colors in response to the beat or a pitch of a song.

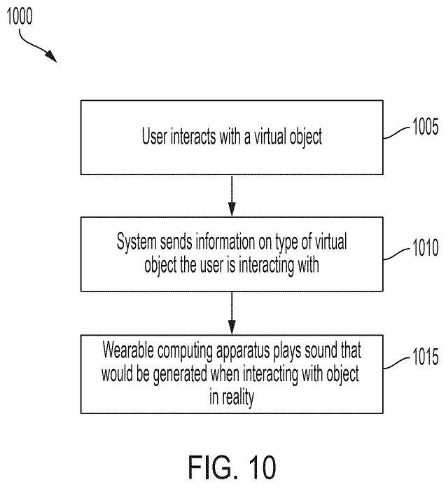

In some embodiments, wearable computing apparatuses 700, 800, 900 can utilize speakers and/or subwoofers to enhance the immersive experience of the user. FIG. 10 is a flow diagram of an example embodiment of a method 1000 for providing sound in an immersive computing environment. At Step 1005, a user interacts with a virtual object utilizing any of the wearable computing apparatuses described herein. At Step 1010, the system (e.g., software in the wearable computing apparatus itself, or a computing device that is in wireless communication therewith) sends information on the type of virtual object the user is interacting with to the wearable computing apparatus. At Step 1015, the wearable computing apparatus can output a sound that would be generated when interacting with the same object in reality. For example, if a user grabs a “virtual” plastic bag in virtual or augmented reality, the wearable computing apparatus can recognize the virtual object being interacted with and output a sound that would be produced if a user were actually touching a plastic bag in reality. As another example, if a user knocks on a “virtual” door in virtual or augmented reality, the wearable computing device can be configured to output a sound similar to a door being knocked on in reality.

FIG. 11 is a flow diagram of another example embodiment of a method 1100 for providing sound in an immersive computing environment. At Step 1105, a user interacts with a real object while wearing any of the wearable computing apparatuses described herein. At Step 1110, the sound made during the user's interaction with the real object is captured by a microphone embedded in the wearable computing apparatus. At Step 1115, the user's movements and the manner in which the user is interacting with the real object are captured by the sensors and cameras of the wearable computing apparatus. For example, through positional tracking of the user's hand and fingers, the specific interaction (e.g., knocking, tapping, squeezing, petting) can be associated with the sound captured by the microphone at Step 1110. At Step 1120, the user interacts with a virtual object (e.g., virtual plastic bag) associated with the real object (e.g., real plastic bag) interacted with at Step 1105. At Step 1125, the wearable computing apparatus determines if the same movement and manner of interaction are being performed by the user. If so, then at Step 1130, the wearable computing apparatus reproduces the sound captured at Step 1110.

The use cases for the multicolored LEDs, speakers, subwoofers, and microphone described above are intended to be illustrative and non-limiting in nature, and those of skill in the art will understand that other uses, as well as modifications to the described uses, for the components are within the scope of the present disclosure. Likewise, those of skill in the art will recognize that these uses of these components are not limited to a particular wearable computing apparatus and are freely combinable with any of the embodiments of wearable computing apparatuses described herein.

### Embodiments of Communications Between Two or More Wearable Computing Devices

Example embodiments of methods for communication between two or more wearable computing devices, and their respective operations, will now be described. According to one aspect of the embodiments, two or more wearable computing devices, each having one or more multicolored LEDs and/or sensors disposed in a distal portion of the wearable computing device, can be configured to communicate with each other through wired or wireless communications. In many of the embodiments described herein, one or more sensors of a first wearable computing device can be configured to track a relative motion and/or position of the hand and fingers on which the first wearable computing device is worn, and one or more multicolored LEDs of a second wearable computing device can be configured to generate a visual output, i.e., colored light, to the user of the second wearable computing device.

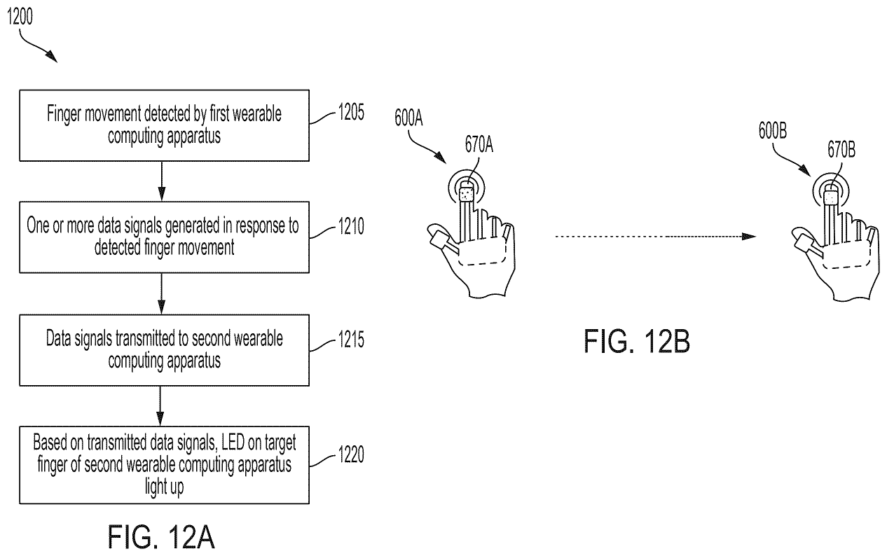

FIG. 12A is a flow diagram of an example embodiment of a method 1200 for communication between two or more wearable computing devices. As an initial matter, those of skill in the art will understand that the wearable computing devices described herein can include any or all of the wearable computing apparatuses and/or devices described herein, and the routines and subroutines described herein comprise instructions stored in a non-transitory memory of a controller which, when executed by one or more processors, cause the one or more processors to perform the method steps of the described routines and subroutines.

Referring now to FIG. 12A, method 1200 begins at Step 1205 when one or more sensors of a first wearable computing device detects a finger movement by the user of the first wearable computing device. In some embodiments, the one or more sensors can include one or more gyroscope sensors, accelerometers, magnetometers, or any of the other components configured to sense a hand/finger movement and/or position, as described above.

At Step 1210, the one or more sensors of the first wearable computing device generates one or more data signals in response to detecting the finger movement. At Step 1215, the one or more data signals are transmitted wirelessly, via a wireless communication module, to a second wearable computing device. In some embodiments, the one or more data signals can be transmitted wirelessly according to one or more of an 802.11x, Bluetooth, Bluetooth Low Energy, or NFC protocol, or any other standard wireless networking protocol.

According to another aspect of the embodiments, a wireless communication module of the second wearable computing device receives the transmitted one or more data signals. The second wearable computing device can also include one or more multicolored LEDs, one or more processors, and a memory coupled thereto. At Step 1220, instructions stored in memory of the second wearable computing device are executed by the one or more processors, causing the one or more processors to translate the received one or more data signals into one or more commands sent to the one or more multicolored LEDs. As a result, an LED on a target finger of the second wearable computing device lights up. In some embodiments, the LED can be configured to light up in a predetermined color (e.g., blue).

Although method 1200 depicts the transmission of the one or more data signals from the first wearable computing device to the second wearable computing device, those of skill in the art will understand that the first wearable computing device can instead be a controller, buttons on a keyboard, an app, or any signaling device. Furthermore, although the transmission of data signals is described as being performed wirelessly, those of skill in the art will appreciate that the data signals can also be transmitted via wired communications between the first wearable computing device and the second wearable computing device.

An example embodiment of method 1200 will now be described. A user of a first wearable computing device makes a finger movement with her index finger. The finger movement is detected by one or more gyroscope sensors disposed in the distal portion 670A of the first wearable computing device 600A, and one or more data signals are generated in response thereto. Subsequently, the one or more data signals are wirelessly transmitted, via a wireless communication module of the first wearable computing apparatus, to a second wearable computing apparatus. The second wearable computing device 600B then receives the one or more data signals and programmatically generates a visual output to the multicolored LED disposed in the distal portion 670B attached to the index finger of the user of the second wearable computing device 600B.

As can be seen in FIG. 12B, those of skill the art will recognize that the communication of data signals between first wearable computing device 600A and the second wearable computing device 600B can be either performed via a unidirectional communication link or, optionally, a bidirectional communication link. For example, according to some embodiments where inter-device communications are bidirectional, a finger movement detected by the second wearable computing device can also cause a visual output response to be generated in the first wearable computing device.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step may be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

To the extent the embodiments disclosed herein include or operate in association with memory, storage, and/or computer readable media, then that memory, storage, and/or computer readable media are non-transitory. Accordingly, to the extent that memory, storage, and/or computer readable media are covered by one or more claims, then that memory, storage, and/or computer readable media is only non-transitory.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

1-27. (canceled)

28. A wearable computing device adapted to be worn on a user's hand and configured for spatial computing interactions, the wearable computing device comprising:
a controller portion, comprising:
a depth camera and one or more time-of-flight sensors;
a first set of sensors adapted to sense a plurality of positional characteristics associated with the user's hand;
one or more processors; and
a non-transitory memory coupled to the one or more processors, the non-transitory memory configured to store instructions; and
a plurality of flexible leads coupled with the controller portion, wherein each of the plurality of flexible leads is configured to be removably secured to each finger of the user's hand, and
wherein a distal portion of each flexible lead includes a second set of sensors adapted to sense a plurality of positional characteristics associated with the each finger,
wherein the depth camera and the one or more time-of-flight sensors are configured to acquire spatial information of a target object.

29. The wearable computing device of claim 28, wherein the instructions stored in the non-transitory memory, when executed by the one or more processors, cause the one or more processors to:
detect, based on at least one of the plurality of positional characteristics associated with the user's hand sensed by the first set of sensors and the plurality of positional characteristics associated with the each finger, a pointing gesture indicating the target object,
scan, by the depth camera and the one or more time-of-flight sensors, the indicated target object to acquire the spatial information thereof.

30. The wearable device of claim 29, wherein the acquired spatial information comprises geometric characteristics of the indicated target object.

31. The wearable computing device of claim 30, wherein the geometric characteristics of the indicated target object include one or more of a height, a width, and a length.

32. The wearable computing device of claim 30, wherein the geometric characteristics of the indicated target object include a volume.

33. The wearable computing device of claim 29, wherein the indicated target object is a person, and wherein the acquired special information comprises body measurements of the person.

34. The wearable computing device of claim 29, wherein the instructions stored in the non-transitory memory, when executed by the one or more processors, cause the one or more processors to:
transmit the acquired spatial information of the indicated target object to a three-dimensional printer to create a three-dimensional replica of the indicated target object.

35. The wearable computing device of claim 29, wherein the instructions stored in the non-transitory memory, when executed by the one or more processors, cause the one or more processors to:
transmit the acquired spatial information of the indicated target object to a computing device to create a graphical rendering of the indicated target object.

36. The wearable computing device of claim 29, wherein the instructions stored in the non-transitory memory, when executed by the one or more processors, cause the one or more processors to:
compare the acquired spatial information of the indicated target object with spatial information of other objects in a database.

37. The wearable computing device of claim 36, wherein comparison of the acquired spatial information of the indicated target object with the spatial information of other objects in the database comprises comparing geometric characteristics of the indicated target object with geometric characteristics of the other objects in the database.

38. The wearable computing device of claim 36, wherein comparison of the acquired spatial information of the indicated target object with the spatial information of other objects in the database comprises comparing structural data associated with a face of the indicated target object with structural data associated with faces of other individuals in the database.

39. The wearable computing device of claim 29, wherein the acquired spatial information comprises a distance between the user and the indicated target object.

40. The wearable computing device of claim 39, further comprising:
at least one haptic motor, and
wherein the instructions stored in the non-transitory memory, when executed by the one or more processors, cause the one or more processors to generate a vibratory output to the at least one haptic motor if the distance between the user and the indicated target object is below a predetermined minimum threshold distance.
